(19) United States
(12) Patent Application Publication
(10) Pub. No.: US 2013/0089714 A1
(43) Pub. Date: Apr. 11, 2013

(54) SURFACE DECORATION METHOD AND ELECTRONIC DEVICE

(71) Applicant: Sanyo Electric Co., Ltd., Moriguchi City (JP)

(72) Inventors: Yukiya Maeda, Shijonawate City (JP); Seiya Shibata, Hirakata City (JP)

(73) Assignee: SANYO ELECTRIC CO., LTD., Moriguchi City (JP)

(21) Appl. No.: 13/633,279

(22) Filed: Oct. 2, 2012

(30) Foreign Application Priority Data
Oct. 5, 2011 (JP) 2011-220732

(51) Int. Cl. B05D 3/06; B32B 3/10

(52) U.S. Cl. 428/195.1; 427/511

(57) ABSTRACT

A surface decoration method in which an article for printing that serves as a underlayer is printed with a plurality of lines of ultraviolet curing ink in a row having spaces such that the underlayer is exposed.

This application is based on and claims the benefit of priority from the corresponding Japanese Patent Application No. 2011-220732 filed on Oct. 5, 2011, entitled “Surface Decoration Method and Electronic Device” (inventors: Yukiya Maeda, Seiya Shibata), the contents of which are hereby incorporated by reference.

### BACKGROUND OF THE INVENTION

1. Field of the Invention

The present invention relates to a surface decoration method for using an ultraviolet curing ink (hereinafter denoted as UV ink) for printing (hereinafter sometimes denoted as UV printing), primarily for the purpose of decorating metal components or resin components; and to an electronic device employing the same.

2. Description of Related Art

Techniques for decorating metal components or resin components by UV printing are known in the prior art. For example, there are surface decoration methods for substrates that have glossy metal surfaces, in which a substrate having a glossy metal surface is matte-printed with desired patterns, text, or the like, by employing a screen of a predetermined screen-opening size, together with an ink obtained by dispersing and mixing a fine particulate matting agent into a transparent or translucent viscous ink, or into a transparent or translucent UV ink, so that the mesh pattern of the screen remains on the matte-printed surface.

Many metal members and resin members have gloss, and in cases in which these are decorated by UV printing, a sharp contrast with the underlayer (the surface of the component) is observed. However, in UV printing in the prior art, the patterns constituting the artwork are arbitrary, that is, artwork comparable to those for other printed materials has been employed. For example, solid patterns were employed in portions desired to have a matte feel. For this reason, the issue of whether a pattern is optimal in terms of accentuating the contrast with the underlayer was not taken into consideration.

### SUMMARY OF THE INVENTION

The surface decoration method according to an embodiment of the present invention is intended for printing of an ultraviolet curing ink onto an article for printing that serves as an underlayer, in such a manner that a plurality of lines are printed in a row with spaces therebetween, through which the underlayer is exposed.

### BRIEF DESCRIPTION OF THE DRAWINGS

FIG. 1 is a partly enlarged plan view of a printed article in a first embodiment of the present invention;

FIG. 2A is a partly enlarged plan view of FIG. 1;

FIG. 2B is a cross-sectional view taken along line A-A in FIG. 2A;

FIG. 3 is a cross-sectional view of a printed article having a binder;

FIG. 4 is a partly enlarged plan view of a printed article in a second embodiment of the present invention;

FIG. 5 is a partly enlarged plan view of a printed article in a third embodiment of the present invention;

FIG. 6 is a partly enlarged plan view of a printed article in a fourth embodiment of the present invention;

FIG. 7A is a partly enlarged plan view of a printed article in a fifth embodiment of the present invention; and

FIG. 7B is a cross-sectional view taken along line B-B in FIG. 7A.

### DETAILED DESCRIPTION OF PREFERRED EMBODIMENTS

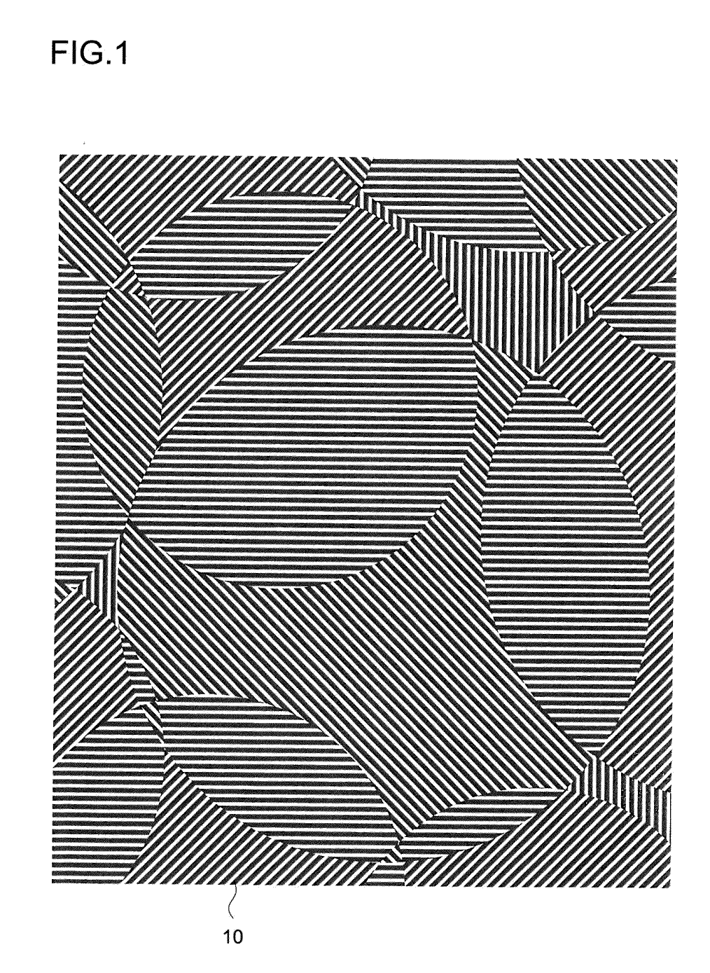

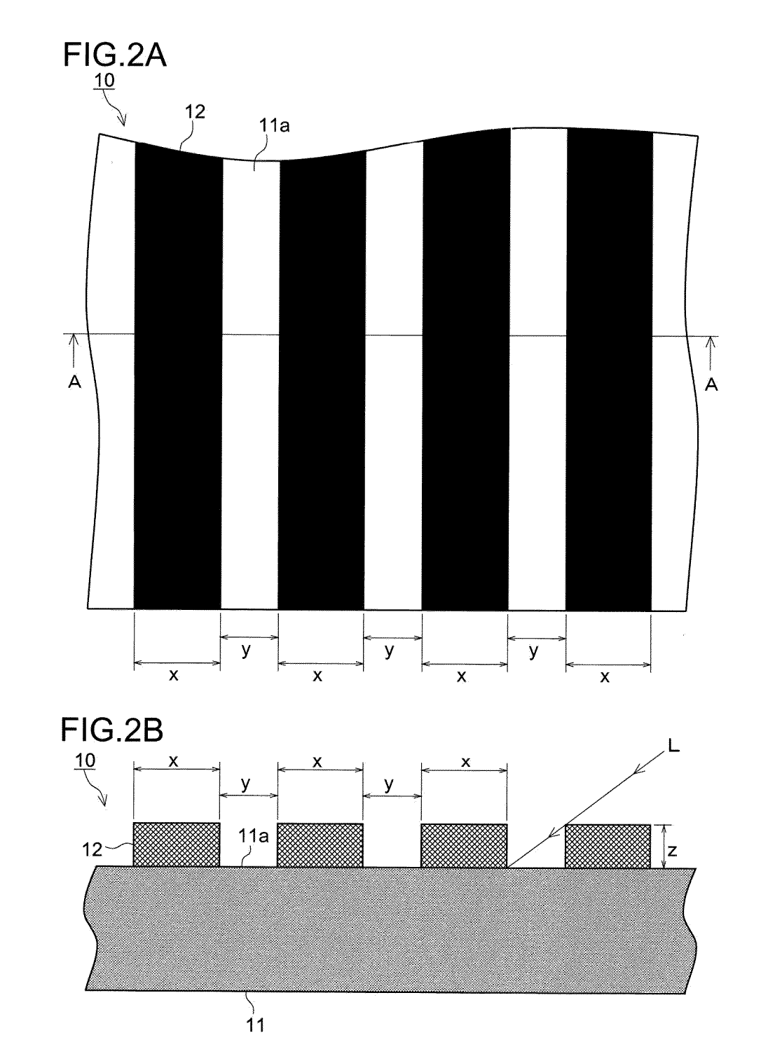

FIG. 1 is a partly enlarged plan view of a printed article in a first embodiment of the present invention. FIG. 2A is a partly enlarged plan view of FIG. 1. FIG. 2B is a cross-sectional view taken along line A-A in FIG. 2A. In FIG. 1 and FIG. 2A, black lines show ink portions while white lines show underlayer portions.

A feature of the surface decoration method of this printed article 10 is that UV ink has been printed onto an article for printing 11 that serves as a underlayer for UV printing, in such a manner that a plurality of lines 12 are printed in a row with spaces y therebetween, through which a underlayer (the surface of the article for printing 11) 11a is exposed. In so doing, there is realized a pattern of sharp contrast between the underlayer section and the ink sections, depending on the direction in which the printed article 10 is viewed, which appears to sparkle brightly when the direction or angle of viewing is varied.

In specific terms, in the printed article 10, the plurality of lines 12 are parallel straight lines having equidistant spacing. Herein, a section of a continuous row of lines 12 in the same direction is termed a group. In the printed article 10, a plurality of these groups are arranged such that the plurality of lines 12 thereof extend in a plurality of directions (in FIG. 1, vertically, horizontally, right diagonally, and left diagonally), thereby forming a pattern resembling overlapping circles.

In the printed article 10, all of the plurality of lines 12 are of equal width x, and the spaces y between the plurality of lines 12 are narrower than the width x of the lines 12. As shown by the arrow L in FIG. 2B, in a state with the lines 12 extending on the horizontal, when viewed on the diagonal from above, the underlayer 11a at the far side may become concealed somewhat, depending on the thickness of the lines 12, and therefore it is preferable for the thickness z of the lines 12 to be about equal to the spaces y.

In specific terms, preferably, the width of the lines 12 is from 0.1 to 0.5 mm, the spaces y between the lines 12 are from 0.1 to 0.5 mm, and the thickness z of the lines is from 0.05 to 0.25 mm; more preferably, the width of the lines 12 is from 0.15 to 0.25 mm, the spaces y between the lines 12 is from 0.1 to 0.2 mm, and the thickness z of the lines is from 0.1 to 0.2 mm. For example, the width x of the lines may be 0.22 mm, the spaces y between the lines may be 0.15 mm, and the thickness z of the lines may be 0.15 mm.

In a case in which the article for printing 11 is made of glossy material, the lines 12 are printed with a matte appearance, whereas in a case in which the article for printing 11 is made of non-glossy material, the lines 12 are printed with a gloss appearance. For example, when a printed article 10 in which the article for printing 11 is made of glossy material onto which the lines 12 have been printed with a matte appearance is viewed on the diagonal from above, for groups in which the lines 12 extend horizontally, the underlayer 11a is concealed to a certain extent, thereby giving a matte appearance; for groups in which the lines 12 extend vertically, the underlayer 11a is not concealed, thereby giving a gloss appearance; and for groups in which the lines 12 extend diagonally left or right, the underlayer 11a is slightly concealed, thereby giving an intermediate appearance somewhere between a matte appearance and a gloss appearance. In so doing, the contrast between adjacent groups becomes sharp, and the shapes of the groups can be more clearly distinguished as patterns, as compared with representation by light and dark ink tones. Moreover, the texture of the underlayer can be utilized in representation as well. Additionally, the article appears to sparkle brightly when the direction or angle of view is varied.

The term “in a row” mentioned hereinabove refers to a plurality of straight lines or curved lines that are lined up, and includes cases in which lines are not parallel. Moreover, “in a row” is used to include both cases in which a plurality of straight lines are parallel, and cases in which a plurality of identically-shaped curved lines are lined up so as to not intersect. Consequently, provided that the plurality of lines 12 are lined up, they need not necessarily be parallel, and may be curved lines as well. Patterns of sharp contrast can be realized in analogous fashion in such cases as well, and will appear to sparkle brightly when the direction or angle of view is varied.

The article for printing 11 is not particularly limited, provided it can be printed with UV ink, and any desired material such as metal, resin, paper, cloth, or the like can be employed. Nor is the printing method particularly limited, provided that a printing method suited to the article for printing 11 is employed. For example, in the case of printing a metal component or a resin component that is an exterior member of an electronic device, it is preferable to employ screen printing or pad printing, by which it is possible to print curved surfaces as well. Moreover, with screen printing or pad printing, modifications to design and color tone are easy and costs are low, and therefore such methods are compatible with high-mix, low-volume production.

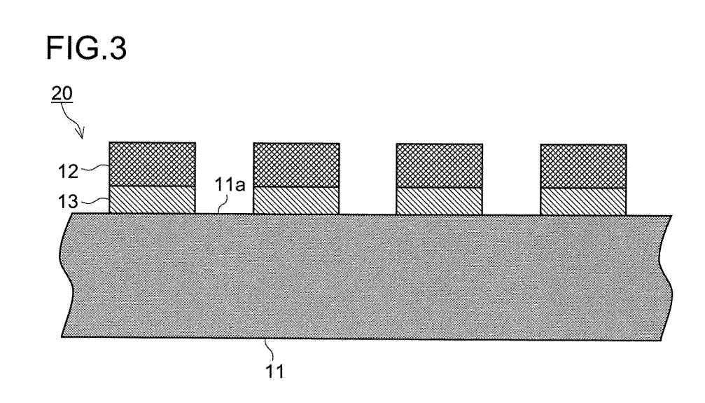

In a case of UV printing of a metal surface, it is preferable to print or coat the metal surface beforehand with a resin-based binder to improve adhesion of the UV ink. FIG. 3 is a cross-sectional view of a printed article 20 having a binder 13. On the printed article 20, the binder 13 constituted by a polyurethane-based ink has been printed in a pattern identical to the pattern to be printed, onto an article for printing 11 constituted by an aluminum component that has undergone alumite treatment. The underlayer 11a is left exposed thereby, and therefore the glossy feel of the metal of the underlayer 11a is not lost.

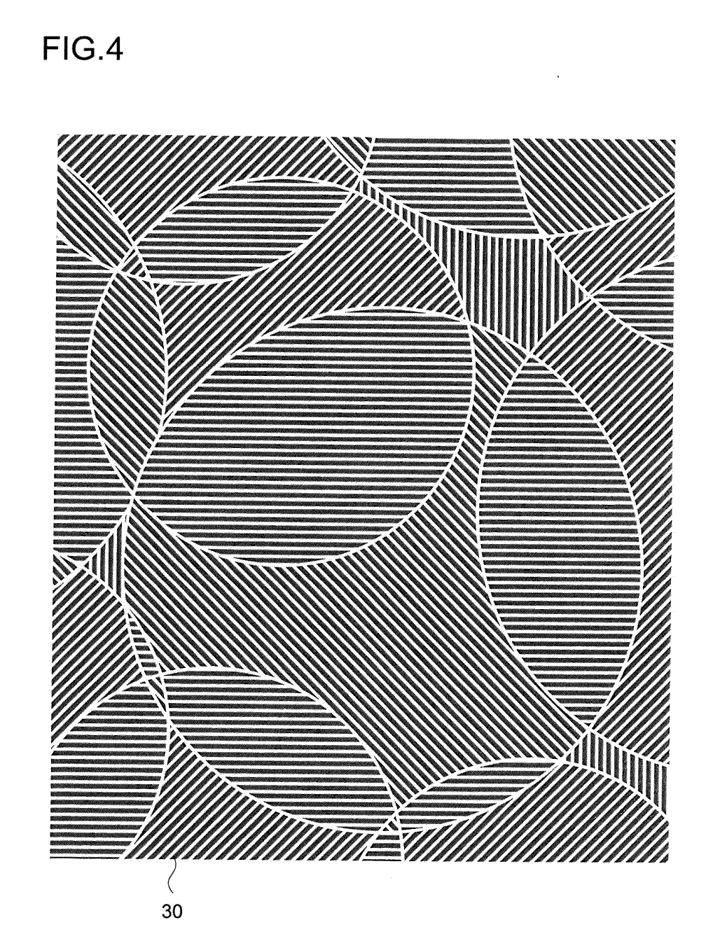

FIG. 4 is a partly enlarged plan view of a printed article in a second embodiment of the present invention. The partly enlarged plan view in FIG. 4 is analogous to FIG. 2A, while the cross-sectional view thereof is analogous to FIG. 2B, and is therefore omitted here.

A printed article 30 of FIG. 4 differs from the printed article 10 of FIG. 1 in that groups constituted by plurality of lines 12 are arranged adjacently to each other with constant spaces therebetween such that the underlayer 11a is exposed. Specifically, the white curved lines in FIG. 4 correspond to these constant spaces; in FIG. 4, the spaces are the same as the spaces y between the lines 12. The constant spaces are not particularly limited, provided that the spaces are visible. Moreover, constant spaces may also be furnished between only a portion of the groups.

By furnishing spaces between the groups in this manner, the boundaries of the groups, which in the printed article 10 of FIG. 1 have an undulating appearance, can be made to appear smooth, improving the design.

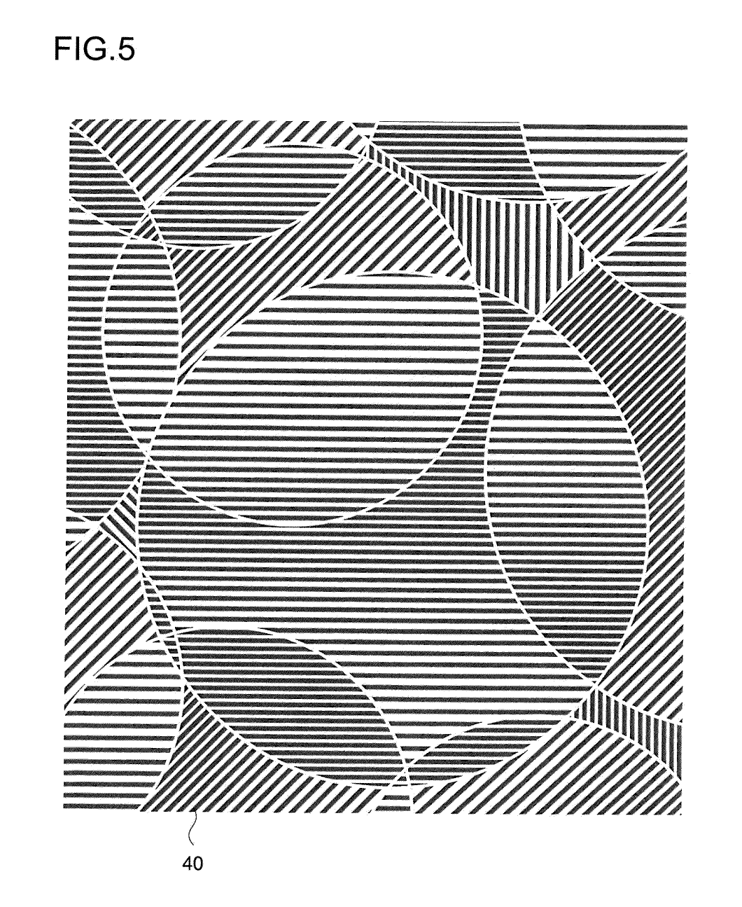

FIG. 5 is a partly enlarged plan view of a printed article in a third embodiment of the present invention. The partly enlarged plan view of FIG. 5 accords with FIG. 2A, while the cross-sectional view accords with FIG. 2B and is accordingly omitted here. A printed article 40 of FIG. 5 differs from the printed article 30 of FIG. 4 in that the plurality of lines 12 form rows having gradually varying spaces. Specifically, while the width x of the lines 12 is the same, the spaces y between the lines 12 become gradually wider or gradually narrower.

By gradually varying the spaces y between the lines 12 in this manner, the proportion of the lines 12 and the underlayer 11a varies, and therefore gradations in contrast can appear, imparting variation to the design.

The width x of the lines 12 may also be gradually varied. Further, both the width x of the lines 12 and the spaces y may be gradually varied. Analogous effects are obtained by doing so.

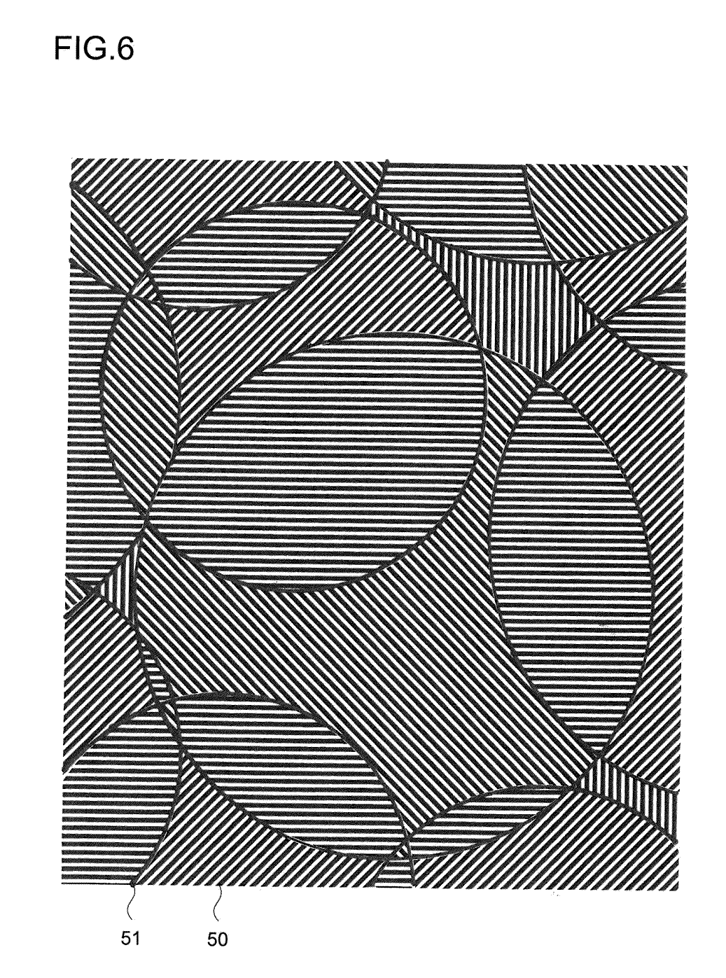

FIG. 6 is a partly enlarged plan view of a printed article in a fourth embodiment of the present invention. The partly enlarged plan view of FIG. 6 is analogous to FIG. 2A, while the cross-sectional view is analogous to FIG. 2B and is therefore omitted here. A printed article 50 of FIG. 6 differs from the printed article 10 of FIG. 1 in that that the groups composed of the plurality of lines 12 have printed lines 51 adjacent to their outside circumference. Specifically, the black curved lines in FIG. 6 correspond to the printed lines 51, and in FIG. 6 are the same width as the lines 12. The width of the printed lines 51 is not particularly limited. It is acceptable also to furnish the printed lines 51 only at necessary locations on the printed article 50.

By furnishing the printed lines 51 in this manner, entry of air bubbles into the lines 12 can be minimized, even in printed sections where the direction of movement of the squeegee is substantially at a right angle to the lines 12 during screen printing. Therefore, printing can be done more sharply.

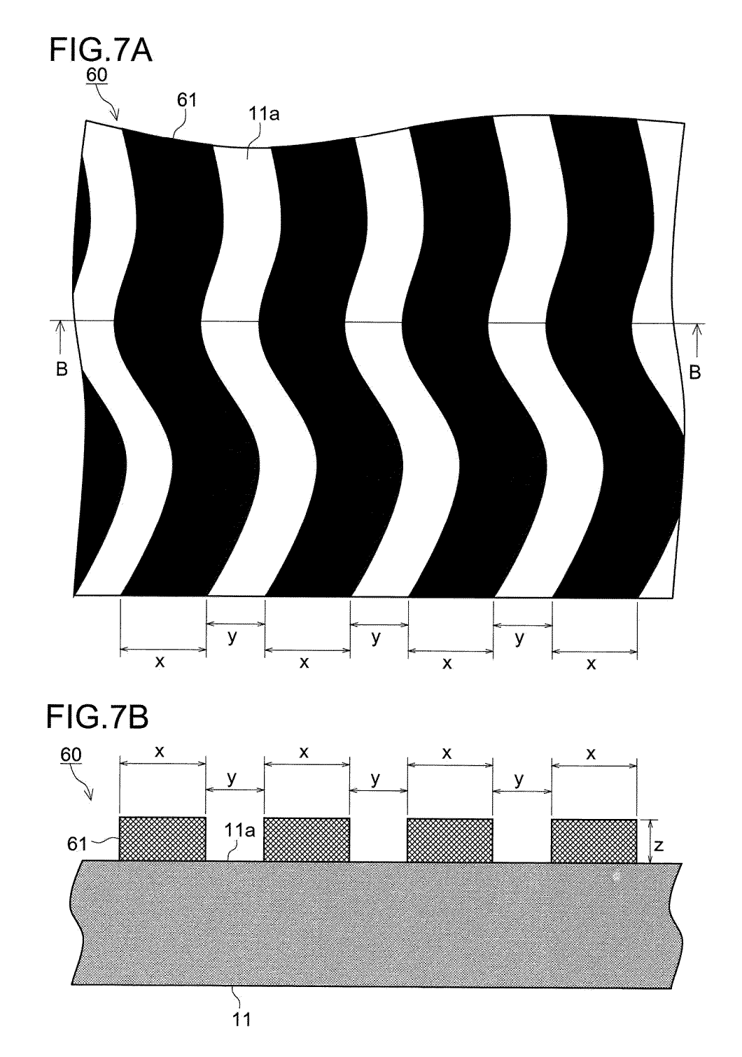

FIG. 7A is a partly enlarged plan view of a printed article in a fifth embodiment of the present invention; and FIG. 7B is a cross-sectional view taken along line B-B in FIG. 7A. A printed article 60 of FIGS. 7A and 7B differs from the printed article 10 of FIGS. 2A and 2B in that the lines 61 are curved lines. The lines 61 are parallel.

Even in a case such as this, in which the lines 61 are curved lines, the contrast between adjacent groups becomes sharp in a manner analogous to the case of straight lines, and the shapes of the groups can be more clearly distinguished as patterns, as compared with representation by light and dark ink tones. Moreover, the texture of the underlayer can be utilized in representation as well. Additionally, the article appears to sparkle brightly when the direction or angle of view is varied. Furthermore, in the case of curved lines, contrast varies even within a single group, and therefore a more complex pattern can be represented. Analogous effects may be obtained with lines that are combinations of straight lines and curved lines, or lines that are combinations of straight lines (broken lines).

In the present invention, either single-color printing or multiple-color printing may be employed to print the lines. For example, a broader width of representation can be achieved with multiple color printing employing a different color for each group.

In the present invention, shading can be represented through the width, spacing, and thickness of the lines, and artwork can be represented through the shape and disposition of the groups. Therefore a variety of artwork besides geometric patterns, such as human figures or landscapes, can be represented as well.

Although the aforementioned embodiments described examples of cases in which lines are printed, instead of lines, dots of arbitrary shape arranged in a linear arrangement may be printed.

The surface decoration method set forth above can be utilized in decorating printable members, including exterior members of electronic devices, and is suitable for utilization with electronic devices such as digital cameras, mobile phones, mobile information terminals, and the like. For example, in the case of a digital camera, the method can be utilized for the slide cover on the front face.

What is claimed is:

1. A surface decoration method which prints an article for printing that serves as a underlayer, with a plurality of lines of ultraviolet curing ink in a row having spaces such that the underlayer is exposed.

2. The surface decoration method according to claim 1, the plurality of lines being straight lines.

3. The surface decoration method according to claim 2, a plurality of groups comprising the plurality of lines being arranged such that the plurality of lines extend in a plurality of directions.

4. The surface decoration method according to claim 1, the plurality of lines being in a row having equal spacing or gradually varying spacing.

5. The surface decoration method according to claim 1, groups comprising the plurality of lines being arranged adjacently to each other at constant spacing such that the underlayer is exposed.

6. The surface decoration method according to claim 1, groups comprising the plurality of lines having a printed line adjacent to the outside circumference thereof.

7. The surface decoration method according to claim 1, the plurality of lines having equal width, and the spacing of the plurality of lines being narrower than the width of the plurality of lines.

8. An electronic device provided with an exterior member decorated by the surface decoration method according to claim 1.
